(19) United States
(12) Patent Application Publication
(10) Pub. No.: US 2024/0213533 A1
(43) Pub. Date: Jun. 27, 2024

(54) ADDITIVE FOR LOW TEMPERATURE LITHIUM ION BATTERY, AND ELECTROLYTE AND LITHIUM ION BATTERY USING SAME

(71) Applicant: JINHUA CHENYANG TECHNOLOGY CO., LTD., Jinghua, Zhejiang (CN)

(72) Inventor: Zhongwei Chen, Jinghua, Zhejiang (CN)

(21) Appl. No.: 17/425,924

(22) PCT Filed: Dec. 7, 2018
(86) PCT No.: PCT/CN2018/119678

§ 371 Date: Jul. 26, 2021

(51) Int. Cl. H01M 10/0567; H01M 10/0525; H01M 10/0568; H01M 10/0569

(52) U.S. Cl. CPC H01M 10/0567; H01M 10/0525; H01M 10/0568; H01M 10/0569

(57) ABSTRACT

An additive for a functionalized metal-organic framework material of a low temperature lithium-ion battery, and a low temperature electrolyte and a low temperature lithium-ion battery using the additive. The electrolyte comprises an organic solvent, a composite lithium salt and an additive, wherein in percentages by mass, the content of the organic solvent is 80-89%, the content of the composite lithium salt is 10-15%, the content of the additive is 0.1-10%, and the additive is an MOF-functionalized additive. The use of the electrolyte in a lithium-ion battery can significantly improve the stability thereof, and increases the conductivity, the degree of dissociation and the solubility of the electrolyte at a low temperature, enhances the conduction rate of Lit, and improves the structure of a negative electrode solid phase interface film of the lithium-ion battery, and then reduces the low temperature impedance thereof, and improves the high rate capability of the battery.

### TECHNICAL FIELD

The present invention relates to the low-temperature electrolytes for lithium-ion batteries, in particular to an additive for low-temperature lithium-ion batteries and electrolytes and lithium-ion batteries using the additives.

### BACKGROUND

Electrolyte, as a place where lithium-ions are conducted between the positive and negative electrodes, is called the “blood” of lithium-ion batteries, which has a vital impact on battery life, safety, and rate performance. However, when lithium-ion battery-powered equipment, such as mobile phones, measuring instruments, computers, and automobiles, are used in winter or in high-cold areas, the equipment cannot operate normally because the battery cannot provide enough power. The main factor leading to this phenomenon is the narrow operating temperature range of the electrolyte, especially at low temperatures, the conductivity of the electrolyte and the interface structure formed with the positive and negative electrodes have almost a decisive effect on the low-temperature performance of the battery. The usual improvement method is to add a certain number of functional components such as film forming, flame retardant, overcharge resistance, etc. to the electrolyte as additives to improve the performance of the electrolyte. At present, the electrolyte of commercial lithium-ion batteries generally adopts EC (ethylene carbonate)-based electrolyte, and the main component is LiPF₆ (lithium hexafluorophosphate)/EC+DMC (other carbonate co-solvents). However, at low operating temperatures, such as −10 to −40° C., how to choose additives with specific functions while maintaining high-rate performance of the battery is still an important challenge in the field of lithium-ion battery electrolytes.

Metal-organic framework materials (MOFs) are a kind of coordination polymer that has developed rapidly in the past ten years. It has a three-dimensional pore structure. Generally, metal ions are used as connection points, and organic ligands are supported to form a 3D extension of space. It is a kind of another important new type of porous material which is widely used in catalysis, energy storage and separation. MOFs have good applications in the fields of catalysis, adsorption separation and identification due to their adjustable structure. In recent years, the functionalization of MOFs by post-modification methods can adjust their physical and chemical properties, so that the modified MOFs can be used in more fields.

There have been some reports on low-temperature electrolyte materials in the prior art. For example, CN102832409A discloses a lithium-ion battery low-temperature electrolyte containing lithium borate-based electrolyte salt and a preparation method thereof; CN103413970A discloses a polydimethylsiloxane-containing low-temperature electrolyte Low-temperature lithium carbonate lithium battery electrolyte containing alkane, 1,3-propane sultone and vinylene carbonate additives; CN103500850B discloses a kind of electrolyte containing γ-valerolactone (GVL) and vinylene carbonate (VC), Ethylene sulfite (ES), propylene sulfite (PS) additives, ternary nickel-cobalt-manganese material (NMC523) battery low-temperature electrolyte; CN101685880A discloses a preparation method of low-temperature lithium-ion battery electrolyte based on reduced pressure distillation to remove impurities and molecular sieve/alkali metal adsorption dehydrated; CN101645521A discloses a method for preparing low-temperature functional electrolyte for lithium titanate lithium-ion batteries.

Although low-temperature electrolytes for lithium batteries are disclosed, the application of MOFs to lithium-ion electrolytes to improve the rate performance of lithium-ion batteries at low temperatures is rarely reported in the prior art. The main differences between these prior arts and the present invention include: (1) The additive materials are different. The present invention also has metal-organic framework materials (MOFs) that do not exist in the prior art. (2) The preparation method is different. The present invention functionalizes MOFs and other conventional additives. The material of the present invention is a functionalized metal-organic framework material additive and the application of a low-temperature electrolyte containing the material in a lithium-ion battery. The MOFs in this material have the advantages of controllable pore size and large specific surface area. Through its functionalization, it can significantly enhance the structural stability of the additive itself, improve the physical properties of the electrolyte at low temperatures, enhance the Lit conductivity rate, and improve the solid phase of the battery negative electrode. The structure of the interface film further improves the rate performance of the battery.

Based on the above, a low-temperature electrolyte for lithium-ion batteries is expected. The electrolyte contains functionalized metal-organic framework material additives. MOFs can significantly improve its stability and improve the conductivity, dissociation and solubility of the electrolyte at low temperatures, enhance the Lit conductivity rate, improve the structure of the solid phase interface film of the negative electrode of the lithium-ion battery, thereby reducing its low-temperature resistance and improving the high-rate performance of the battery.

### SUMMARY OF THE INVENTION

The technical problem to be solved by the present invention is to provide an additive for low-temperature lithium-ion batteries and an electrolyte and lithium-ion batteries using the additive. The functionalized metal-organic framework material additive material has the advantages of controllable pore size, large specific surface area, etc., and its application in the electrolyte of lithium-ion batteries enables the battery to have excellent low-temperature performance and high-rate performance, low cost, and suitable for industrialization produce.

The purpose of the present invention and the solution of its technical problems are achieved by adopting the following technical solutions. According to the present invention, a functionalized metal-organic framework material additive for low-temperature lithium-ion batteries is proposed, and the additive is a functionalized metal-organic framework material.

The aforementioned functionalized metal-organic framework material additives are selected one or more from MOFs functionalized vinylene carbonate and its derivatives, MOFs functionalized fluorovinylene carbonate and its derivatives, MOFs functionalized γ-valerolactone and its derivatives, MOFs functionalized vinyl sulfite and its derivatives, MOFs functionalized propylene sulfite and its derivatives, MOFs functionalized polyethylene oxide and its derivatives, MOFs functionalized methacryloxyethyl trimethylammonium chloride or MOFs functionalized polyvinylpyrrolidone and its derivatives.

The aforementioned MOFs are selected from one or more of ZIF-67, ZIF-8, MOF-5, UIO-66, HKUST-1, and PCN-14.

The purpose of the present invention and solving its technical problems are also achieved by adopting the following technical solutions. According to a low-temperature electrolyte provided by the present invention, the low-temperature electrolyte includes an organic solvent, a complex lithium salt, and the above-mentioned additives, wherein in percentages by mass, the content of the organic solvent is 80-89%, the content of the composite lithium salt is 10-15%, and the content of the additive is 0.1-10%.

The content of the aforementioned additives is 1.5-4%.

The aforementioned organic solvent is selected from one or more of ethylene carbonate, propylene carbonate, dimethyl carbonate, ethyl methyl carbonate, methyl propyl carbonate, methyl acetate, N-methylpyrrolidone, tetrahydrofuran, and dimethyl ether.

The aforementioned composite lithium salt is selected one or more from lithium tetrafluorophosphate, lithium tetrafluoroborate, lithium perchlorate, lithium hexafluoroarsenic (V), lithium dioxalate, lithium difluorooxalate, lithium trifluoromethanesulfonate, lithium bis(trifluoromethanesulfonate) imide.

The purity of the aforementioned organic solvent is greater than 99.9 wt %, the moisture content is less than or equal 30 ppm, and the acidity is less than 50 ppm; the purity of the composite lithium salt is greater than 99.9 wt %; the purity of the additive is greater than 99.9 wt %.

The purpose of the present invention and solving its technical problems are also achieved by adopting the following technical solutions. A low-temperature lithium-ion battery proposed according to the present invention includes a positive electrode, a negative electrode and an electrolyte, wherein the electrolyte is the above-mentioned low-temperature electrolyte.

With the above technical solutions, the present invention has at least the following advantages:

(1) The material claimed by the present invention is a functionalized metal-organic framework material additive and a low-temperature electrolyte containing the material and its application in low-temperature lithium-ion batteries. The MOFs in the additive have the advantages of controllable pore size and large specific surface area. By functionalizing MOFs with conventional additives, the structural stability and low-temperature performance of the additive itself can be significantly enhanced.

(2) The present invention also provides an electrolyte containing a functionalized metal-organic framework material additive. The electrolyte not only retains the performance of the original electrolyte, but also fully demonstrates the low temperature performance of the additive, which significantly improves the physical properties of the electrolyte at low temperatures, enhances the Lit conductivity rate and improves the structure of the solid phase interface film of the battery negative electrode.

(3) The present invention also provides a low-temperature lithium-ion battery, in which the electrolyte is an additive using functionalized metal-organic framework materials, and the MOFs functionalized additive has a porous structure and a high specific surface area, so that even in low temperature conditions, lithium-ion batteries can also maintain excellent low-temperature performance and high-rate performance.

(4) Compared with the conventional lithium-ion battery without MOFs functional additive electrolyte, the lithium-ion battery of the present invention containing MOFs functional additive electrolyte has significantly lower battery impedance; the conductivity of the battery at a normal temperature of 25° C. and a low temperature— 10° C., −30° C. and −50° C. is higher, indicating that the electrolyte has good low-temperature conductivity, and even at −30° C., its conductivity is still as high as 1.0×10⁻³ S/cm; the maximum discharge capacity at room temperature can reach 84% of the battery capacity when discharged at a rate of 40 C, and a large rate discharge can be achieved.

### DESCRIPTION OF THE DRAWINGS

FIG. 1 is a schematic diagram of the structure of MOFs functionalized vinylene carbonate and its derivatives as additives;

FIG. 2 is a schematic diagram of the structure of MOFs functionalized fluorovinylene carbonate and its derivatives as additives;

FIG. 3 is a schematic diagram of the structure of MOFs functionalized γ-valerolactone and its derivatives as additives;

FIG. 4 is a schematic diagram of the structure of MOFs functionalized propylene sulfite and its derivatives as additives;

FIG. 5 is a schematic diagram of the structure of MOFs functionalized vinyl sulfite and its derivatives as additives;

FIG. 6 is a schematic diagram of the structure of MOFs functionalized polyethylene oxide and its derivatives as additives;

FIG. 7 is a schematic diagram of the structure of MOFs functionalized methacryloxyethyltrimethylammonium chloride as additives;

FIG. 8 is a schematic diagram of the structure of MOFs functionalized polyvinylpyrrolidone and its derivatives as additives;

FIG. 9 is a SEM characterization diagram of the MOFs functionalized additive ZIF-8-VC according to the present invention;

FIG. 10 is a TEM characterization diagram of the MOFs functionalized additive ZIF-8-VC according to the present invention;

FIG. 11 is a SEM characterization image of the MOFs functionalized additive UIO-66-GVL according to the present invention;

FIG. 12 is a TEM characterization diagram of the MOFs functionalized additive UIO-66-GVL according to the present invention;

13 is a comparison diagram of EIS test results of lithium-ion batteries obtained in Example 1, Control Example 1 and Control Example 2 of the present invention at 25° C.;

14 is a comparison diagram of the electrical conductivity test results of the electrolyte obtained in Example 1, Control Example 1 and Control Example 2 of the present invention at different temperatures;

FIG. 15 is a battery discharge curve performance of a low-temperature lithium-ion battery obtained in Example 1 according to the present invention at different rates;

FIG. 16 shows the battery discharge curve performance at different temperatures of the low-temperature lithium-ion battery obtained in Example 1 of the present invention;

FIG. 17 shows the battery discharge curve performance at 10C and 20C of the lithium-ion battery obtained in Example 1 and Control Example 1 of the present invention.

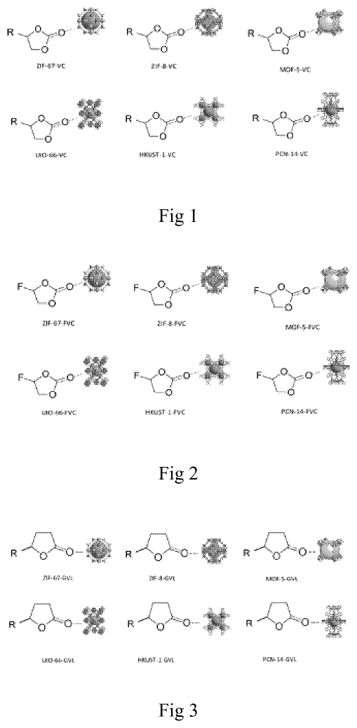

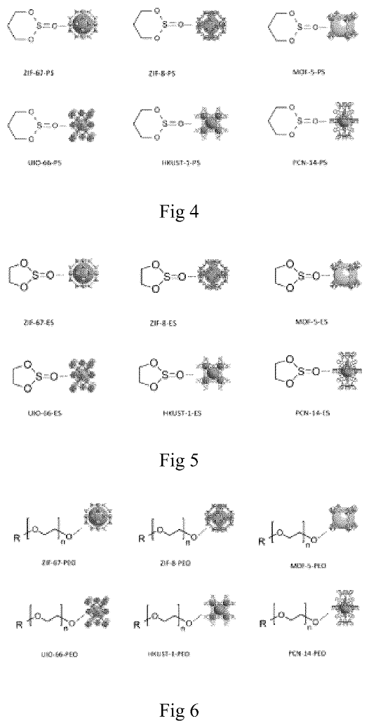

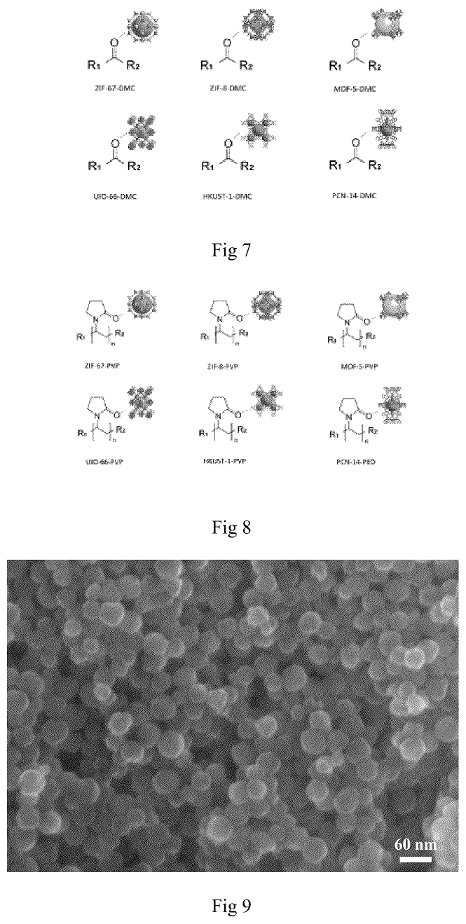

### DETAILED DESCRIPTION OF THE INVENTION

### Example 1

In a glove box filled with high-purity argon, weigh a certain amount of propylene carbonate (PC), ethylene carbonate (EC), dimethyl carbonate (DMC), and methyl acetate (MC) with a micro analytical balance. Its mass ratio is 1:4:4:1, as a quaternary mixed organic solvent, accounting for 85% of the total weight of the electrolyte, and using magnetic stirring for 20 minutes. Weigh a certain amount of mixed lithium salt: lithium tetrafluorophosphate (LiPF₄) and lithium bisoxalate borate (LiBOB), accounting for 12% of the total weight of the electrolyte, add them to the above-mentioned quaternary mixed organic solvent, and stir until clear without precipitation. Weigh a certain amount of MOFs functionalized mixed additives ZIF-8-VC and UIO-66-GVL, accounting for 3% of the total weight of the electrolyte, slowly add them to the above solution, stir well, and let stand for 2 hours, then pour into a sealed bottle to get 85% (PC-EC-DMC-MC)/12% (LiPF₄—LiBOB)/3% (ZIF-8-VC-UIO-66-G VL) low temperature electrolyte.

The commercial ternary nickel-cobalt-manganese material (NMC523) was selected for assembly of conventional button cell technology, and the above-mentioned low-temperature electrolyte was used as the electrolyte for lithium-ion batteries to assemble low-temperature lithium-ion batteries. The obtained low-temperature lithium-ion battery is subjected to discharge capacity test and rate performance test at room temperature and low temperature.

### Example 2

In a glove box filled with high-purity argon, weigh a certain amount of propylene carbonate (PC), ethylene carbonate (EC), dimethyl carbonate (DMC), and methyl acetate (MC) with a micro analytical balance. Its mass ratio is 1:4:4:1, as a quaternary mixed organic solvent, accounting for 85% of the total weight of the electrolyte, and using magnetic stirring for 20 minutes. Weigh a certain amount of mixed lithium salt: lithium tetrafluorophosphate (LiPF₄) and lithium bisoxalate borate (LiBOB), accounting for 12% of the total weight of the electrolyte, add them to the above-mentioned quaternary mixed organic solvent, and stir until clear. precipitation. Weigh a certain amount of MOFs functionalized additive ZIF-8-VC, which accounts for 3% of the total weight of the electrolyte. Slowly add it to the above solution, stir well, let it stand for 2 hours, and then pour it into a sealed bottle to obtain 85% (PC-EC-DMC-MC)/12% (LiPF₄—LiBOB)/3% (ZIF-8-VC) low temperature electrolyte.

The commercial ternary nickel-cobalt-manganese material (NMC523) was selected for assembly of conventional button cell technology, and the above-mentioned low-temperature electrolyte was used as the electrolyte for lithium-ion batteries to assemble low-temperature lithium-ion batteries. The obtained low-temperature lithium-ion battery is subjected to discharge capacity test and rate performance test at room temperature and low temperature.

### Example 3

In a glove box filled with high-purity argon, weigh a certain amount of propylene carbonate (PC), ethylene carbonate (EC), dimethyl carbonate (DMC), and methyl acetate (MC) with a micro analytical balance. Its mass ratio is 1:4:4:1, as a quaternary mixed organic solvent, accounting for 85% of the total weight of the electrolyte, and using magnetic stirring for 20 minutes. Weigh a certain amount of mixed lithium salt: lithium tetrafluorophosphate (LiPF₄) and lithium dioxalate borate (LiBOB), accounting for 12% of the total weight of the electrolyte. Add it to the above-mentioned quaternary mixed organic solvent and stir until it is clear without precipitation. Weigh a certain amount of MOFs functionalized mixed additives ZIF-8-VC, UIO-66-GVL and HKUST-1-PS, accounting for 3% of the total weight of the electrolyte. Slowly add it to the above solution, stir well, let it stand for 2 hours, and then pour it into a sealed bottle to obtain 85% (PC-EC-DMC-MC)/12% (LiPF₄—LiBOB)/3% (ZIF-8-VC-UIO-66-G VL-HKUST-1-PS) low temperature electrolyte.

The commercial ternary nickel-cobalt-manganese material (NMC523) was selected for assembly of conventional button cell technology, and the above-mentioned low-temperature electrolyte was used as the electrolyte for lithium-ion batteries to assemble low-temperature lithium-ion batteries. The obtained low-temperature lithium-ion battery is subjected to discharge capacity test and rate performance test at room temperature and low temperature.

### Example 4

In a glove box filled with high-purity argon, weigh a certain amount of propylene carbonate (PC), ethylene carbonate (EC), dimethyl carbonate (DMC), and methyl acetate (MC) with a micro analytical balance. Its mass ratio is 1:4:4:1, as a quaternary mixed organic solvent, accounting for 89% of the total weight of the electrolyte, and using magnetic stirring for 20 minutes. Weigh a certain amount of mixed lithium salt: lithium tetrafluorophosphate (LiPF₄) and lithium dioxalate borate (LiBOB), accounting for 10.9% of the total weight of the electrolyte, add them to the above quaternary mixed organic solvent, and stir until clear and no precipitation. Weigh a certain amount of MOFs functionalized mixed additives ZIF-8-VC and UIO-66-GVL, accounting for 0.1% of the total weight of the electrolyte. Slowly add it to the above solution, stir well, let it stand for 2 hours, and then pour it into a sealed bottle to obtain 89% (PC-EC-DMC-MC)/10.9% (LiPF₄—LiBOB)/0.1% (ZIF-8-VC-UIO-66-GVL) low temperature electrolyte.

The commercial ternary nickel-cobalt-manganese material (NMC523) was selected for assembly of conventional button cell technology, and the above-mentioned low-temperature electrolyte was used as the electrolyte for lithium-ion batteries to assemble low-temperature lithium-ion batteries. The obtained low-temperature lithium-ion battery is subjected to discharge capacity test and rate performance test at room temperature and low temperature.

### Example 5

In a glove box filled with high-purity argon, weigh a certain amount of propylene carbonate (PC), ethylene carbonate (EC), dimethyl carbonate (DMC), and methyl acetate (MC) with a micro analytical balance. Its mass ratio is 1:4:4:1, as a quaternary mixed organic solvent, accounting for 80% of the total weight of the electrolyte, and using magnetic stirring for 20 minutes. Weigh a certain amount of mixed lithium salt: lithium tetrafluorophosphate (LiPF₄) and lithium dioxalate borate (LiBOB), accounting for 10% of the total weight of the electrolyte. Add it to the above-mentioned quaternary mixed organic solvent and stir until it is clear without precipitation. Weigh a certain amount of MOFs functionalized mixed additives ZIF-8-VC and UIO-66-GVL, accounting for 10% of the total weight of the electrolyte. Slowly add it to the above solution, stir well, let it stand for 2 hours, and then pour it into a sealed bottle to obtain 80% (PC-EC-DMC-MC)/10% (LiPF₄—LiBOB)/10% (ZIF-8-VC-UIO-66-GVL) low temperature electrolyte.

The commercialized ternary nickel-cobalt-manganese material (NMC523) was selected for conventional button cell assembly process, and the above-mentioned low-temperature electrolyte was used as the lithium-ion battery electrolyte to assemble the lithium-ion battery. The obtained lithium-ion battery is subjected to discharge capacity test and rate performance test at room temperature and low temperature.

### Control Example 1

In a glove box filled with high-purity argon, weigh a certain amount of propylene carbonate (PC), ethylene carbonate (EC), dimethyl carbonate (DMC), and methyl acetate (MC) with a micro analytical balance. Its mass ratio is 1:4:4:1, as a quaternary mixed organic solvent, accounting for 85% of the total weight of the electrolyte, and using magnetic stirring for 20 minutes. Weigh a certain amount of mixed lithium salt: lithium tetrafluorophosphate (LiPF₄) and lithium dioxalate borate (LiBOB), accounting for 12% of the total weight of the electrolyte, add them to the above quaternary mixed organic solvent, and stir until clear and no precipitation. Weigh a certain amount of mixed additives vinylene carbonate (VC) and γ-valerolactone (GVL), accounting for 3% of the total weight of the electrolyte, slowly add them to the above solution, stir well, and let stand for 2 hours, And then pour it into a sealed bottle to get 85% (PC-EC-DMC-MC)/12% (LiPF₄—LiBOB)/3% (VC-GVL) electrolyte.

The commercialized ternary nickel-cobalt-manganese material (NMC523) was selected for assembly of conventional button cell technology, and the above-mentioned electrolyte was used as the electrolyte of the lithium-ion battery to assemble the lithium-ion battery. The obtained lithium-ion battery is subjected to discharge capacity test and rate performance test at room temperature and low temperature.

### Control Example 2

In a glove box filled with high-purity argon, weigh a certain amount of propylene carbonate (PC), ethylene carbonate (EC), dimethyl carbonate (DMC), and methyl acetate (MC) with a micro analytical balance. Its mass ratio is 1:4:4:1, as a quaternary mixed organic solvent, accounting for 85% of the total weight of the electrolyte, and using magnetic stirring for 20 minutes. Weigh a certain amount of mixed lithium salt: lithium tetrafluorophosphate (LiPF₄) and lithium dioxalate borate (LiBOB), accounting for 12% of the total weight of the electrolyte, add them to the above quaternary mixed organic solvent, and stir until clear and no precipitation. Weigh a certain amount of additive vinylene carbonate (VC), which accounts for 3% of the total weight of the electrolyte. Slowly add it to the above solution, stir well, let it stand for 2 hours, and then pour it into a sealed bottle to obtain 85% (PC-EC-DMC-MC)/12% (LiPF₄—LiBOB)/3% VC Electrolyte.

The commercialized ternary nickel-cobalt-manganese material (NMC523) was selected for assembly of conventional button cell technology, and the above-mentioned electrolyte was used as the electrolyte of the lithium-ion battery to assemble the lithium-ion battery. The obtained lithium-ion battery is subjected to discharge capacity test and rate performance test at room temperature and low temperature.

TABLE 1
Comparison of discharge capacity properties at normal temperature and low temperature
of lithium-ion batteries in Examples 1-5 and Control Examples 1-2

| | 20 C discharge | 20 C discharge | 20 C discharge | 20 C discharge |
|---|---|---|---|---|
| | capacity retention | capacity retention | capacity retention | capacity retention |
| | ratio at 25° C. | ratio at −10° C. | ratio at −30° C. | ratio at −50° C. |
| | (cutoff | (cutoff | (cutoff | (cutoff |
| NO. | voltage3.0 V) | voltage2.5 V) | voltage2.5 V) | voltage2.0 V) |
| Example 1 | ≥91.5% | ≥85.5% | ≥67.3% | ≥62.9% |
| Example 2 | ≥91.8% | ≥84.9% | ≥67.2% | ≥62.1% Ah |
| Example 3 | ≥92.9% | ≥86.0% Ah | ≥68.5% | ≥63.3% Ah |
| Example 4 | ≥91.8% | ≥85.6% | ≥65.9% | ≥61.0% Ah |
| Example 5 | ≥93.3% | ≥86.3% | ≥68.0% | ≥64.2% |
| Control | ≥79.8% | ≥65.5% | cannot discharge | Can not discharge |
| Example 1 | | | (10 C discharge | |
| | | | about 34.1%) | |
| Control | ≥76.5% | ≥58.2% | cannot discharge | Can not discharge |
| Example 2 | | | (10 C discharge | |
| | | | about 28.5%) | |

TABLE 2
Comparison of rate capacities at low temperature of lithium-
ion batteries in Examples 1-5 and Control Examples 1-2

| | |
|---|---|
| No. | rate discharge capacity retention ratio at −30° C. |

| | | | |
|---|---|---|---|
| Example 1 | 1 C (cutoff | 10 C (cutoff | 20 C (cutoff |
| | voltage2.5 V) | voltage2.5 V) | voltage2.5 V) |
| Example 2 | 87.7% | 81.5% | 67.3% |
| Example 3 | 85.8% | 81.8% | 67.2% |
| Example 4 | 88.6% | 82.9% | 68.5% |
| Example 5 | 86.2% | 81.8% | 65.9% |
| Control | 47.5% | 34.1% | CAN NOT |
| Example 1 | | | DISCHARGE |
| Control | 46.2% | 28.5% | CAN NOT |
| Example 2 | | | DISCHARGE |

Table 1 is a comparison of the discharge capacity performance at room temperature and low temperature of lithium-ion batteries in Examples 1-5 and Control Example 1-2 according to the present invention; Table 2 is Examples 1-5 and Control Example according to the present invention Comparison of rate performance of lithium-ion batteries in 1-2 at low temperature. It can be seen from Table 1 that compared with the conventional electrolyte without MOFs functionalization, the discharge capacity performance of the electrolyte based on MOFs functionalization of the present invention at room temperature 25° C. and low temperature −10° C., −30° C. and −50° C. is higher, indicating that the electrolyte has good low-temperature electrolyte performance. The reason is that the Lit conductivity in the electrolyte is enhanced, and the positive electrode/electrolyte interface structure is improved. It can be seen from Table 2 that compared with conventional electrolytes without MOFs functionalization, the MOFs-based electrolytes of the present invention have higher performance at 1C, 10C, and 20C magnifications at a low temperature of −30° C., which proves that the electrolyte additive structure is more stable. The above results also indicate that the electrolyte can be used in low-temperature and high-rate lithium-ion batteries.

The description of the drawings is as follows:

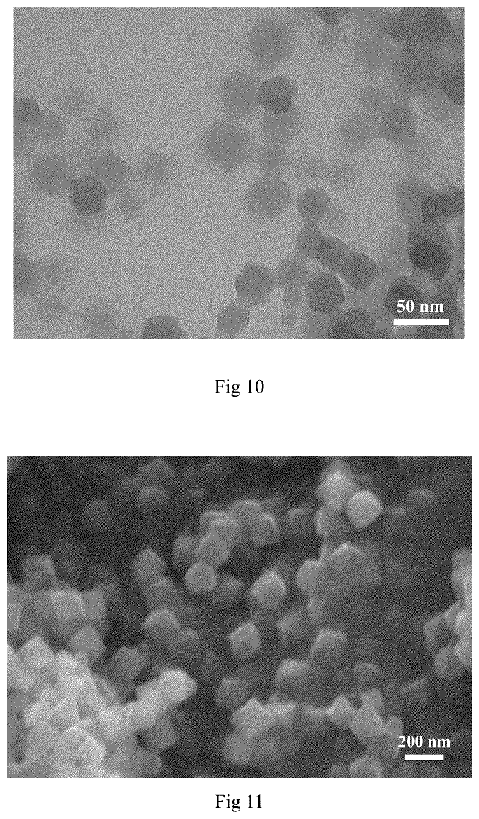

FIG. 9 is a SEM characterization image of the MOFs functionalized additive ZIF-8-VC according to the present invention; FIG. 10 is a TEM characterization image of the MOFs functionalized additive ZIF-8-VC according to the present invention. It can be seen from FIG. 9 that the morphology of the MOFs functionalized additive ZIF-8-VC of the present invention is a hexadecahedron with a size of about 35 nm, which is consistent with the TEM image in FIG. 10.

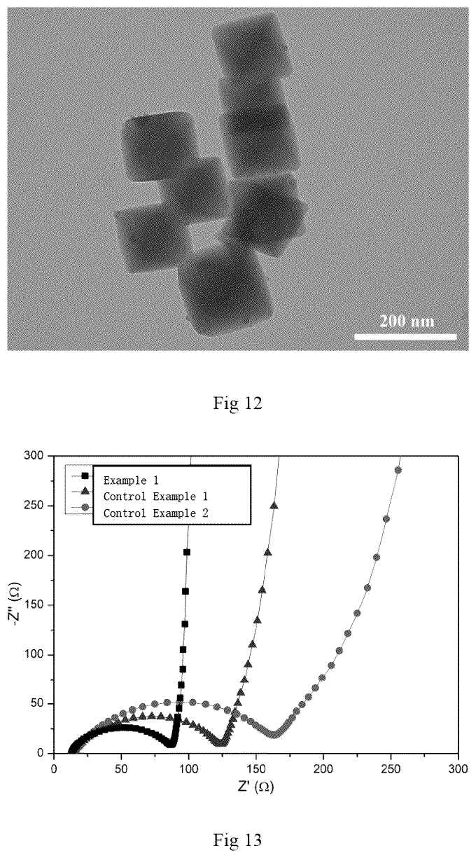

FIG. 11 is a SEM characterization image of the MOFs functionalized additive UIO-66-GVL according to the present invention; FIG. 12 is a TEM characterization image of the MOFs functionalized additive UIO-66-GVL according to the present invention. It can be seen from FIG. 11 that the morphology of the MOFs functionalized additive UIO-66-GVL of the present invention is a regular octahedron with a size of about 150 nm, which is consistent with the TEM image in FIG. 12.

FIG. 13 is a comparison diagram of EIS test results of lithium-ion batteries obtained in Example 1, Control Example 1 and Control Example 2 according to the present invention at 25° C. It can be seen from FIG. 13 that the battery impedances of Example 1, Control Example 1 and Control Example 2 are approximately 850, 1250, and 16502, respectively. The results show that the battery impedance in Example 1 is significantly lower than that in Control Example 1 and Control Example. Example 2.

FIG. 14 is a comparison diagram of the electrical conductivity test results of the electrolyte obtained in Example 1, Control Example 1 and Control Example 2 according to the present invention at different temperatures. It can be seen from FIG. 14 that the MOFs-based functionalized electrolyte of the present invention has higher conductivity at room temperature 25° C. and low temperature −10° C., −30° C. and −50° C. compared with conventional electrolyte solutions. It shows that the electrolyte has good low-temperature conductivity, and its conductivity is as high as 1.0×10⁻³ S/cm even at −30° C.

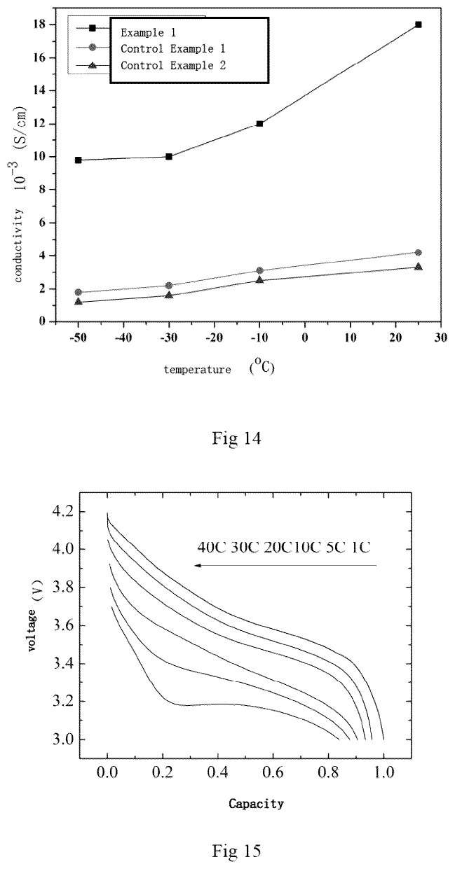

FIG. 15 shows the battery discharge curve performance of the low-temperature lithium-ion battery obtained in Example 1 according to the present invention at different rates. It can be seen from FIG. 15 that the maximum discharge capacity of the battery at room temperature can reach 84% of the battery capacity at a rate of 40C, indicating that the battery can achieve high-rate discharge.

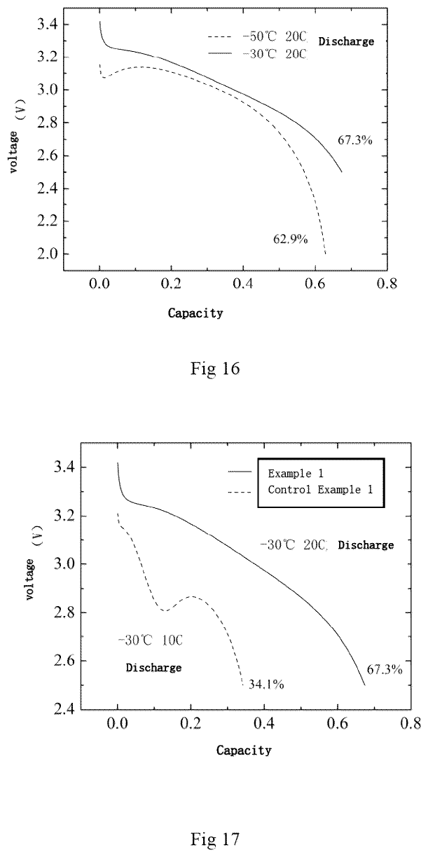

FIG. 16 shows the battery discharge curve performance of the low-temperature lithium-ion battery obtained in Example 1 of the present invention at different temperatures. It can be seen from FIG. 16 that the battery capacity can still maintain 67.3% at a low temperature of −30° C., 20 C and a cut-off voltage of 2.5 V; at a low temperature of −50° C., 20 C and a cut-off voltage of 2.0 V, the capacity of the battery can still maintain 62.9%, showing good low temperature performance.

FIG. 17 shows the battery discharge curve performance at 10C and 20C of the lithium-ion battery obtained in Example 1 and Control Example 1 of the present invention. It can be seen from FIG. 17 that the battery capacity can still maintain 67.3% at a low temperature of −30° C., 20C, and a cut-off voltage of 2.5V. The results of Control Example 1 and Control Example 2 show that charging and discharging cannot be performed at a low temperature of −30° C. and 20C. Control Example 1 is at a low temperature of −30° C., at 10C, and when the cut-off voltage is 2.5V. Only 34.1% of the capacity can be maintained.

In summary, the low-temperature lithium-ion battery of the present invention uses functionalized metal-organic framework material additives. MOFs functionalized additives have a porous structure and a high specific surface area, which significantly improves the physical properties of the electrolyte at low temperatures and enhances the conduction rate of Lit, improves the structure of the solid phase interface film of the negative electrode of the battery, so that the lithium-ion battery can maintain excellent low temperature performance and high rate performance even under low temperature conditions.

The above are only the preferred specific embodiments of the present invention, but the protection scope of the present invention is not limited thereto. Any person skilled in the art can easily think of changes or changes within the technical scope disclosed in the present invention. All replacements should be covered within the protection scope of the present invention. Therefore, the protection scope of the present invention should be subject to the protection scope of the claims.

1. A functionalized metal-organic framework material (MOF) additive for low-temperature lithium-ion batteries, the additive being a functionalized metal-organic framework material.

2. The additive according to claim 1, wherein the functionalized metal-organic framework material additive is selected from one or more MOFs functionalized vinylene carbonate and its derivatives, MOFs functionalized fluorovinylene carbonate and its derivatives, MOFs functionalized γ-valerolactone and its derivatives, MOFs functionalized vinyl sulfite and its derivatives, MOFs functionalized propylene sulfite and its derivatives, MOFs functionalized polyethylene oxide and its derivatives, MOFs functionalized methacryloyloxyethyl trimethylammonium chloride or MOFs functionalized polyvinylpyrrolidone and its derivatives.

3. The additive of claim 1, wherein the MOFs are selected from one or more of ZIF-67, ZIF-8, MOF-5, UIO-66, HKUST-1 and PCN-14.

4. A low-temperature electrolyte, said low-temperature electrolyte comprising an organic solvent, a composite lithium salt, and the additive of claim 1, wherein in percentages by mass, the content of the organic solvent is 80-89%, the content of the composite lithium salt is 10-15%, and the content of the additive is 0.1-10%.

5. The low-temperature electrolyte of claim 4, wherein the content of the additive is 1.5-4%.

6. The low-temperature electrolyte of claim 4, wherein the organic solvent is selected one or more from the group consisting of ethylene carbonate, propylene carbonate, dimethyl carbonate, ethyl methyl carbonate, methyl propyl carbonate, methyl acetate, N-methyl pyrrolidone, tetrahydrofuran and dimethyl ether.

7. The low-temperature electrolyte of claim 4, wherein the composite lithium salt is selected from one or more of the group consisting of lithium tetrafluorophosphate, lithium tetrafluoroborate, lithium perchlorate, lithium hexafluoroarsenic (V), and lithium dioxalate borate, lithium difluorooxalate borate, lithium trifluoromethanesulfonate, and lithium bis (trifluoromethanesulfonate) imide.

8. The low-temperature electrolyte according to claim 4, wherein the purity of the organic solvent is greater than 99.9 wt %, the moisture content is less than or equal 30 ppm, and the acidity is less than 50 ppm; the purity of the composite lithium salt is greater than 99.9 wt %; the purity of the additive is greater than 99.9 wt %.

9. A low-temperature lithium-ion battery, comprising a positive electrode, a negative electrode and an electrolyte, wherein the electrolyte is the low-temperature electrolyte according to claim 4.
